(19) United States
(12) Patent Application Publication
(10) Pub. No.: US 2014/0255636 A1
(43) Pub. Date: Sep. 11, 2014

(54) Polymeric Membranes

(71) Applicant: Saudi Basic Industries Corporation, Riyadh (SA)

(72) Inventors: Ihab Nizar Odeh, Thuwal (SA); Lei Shao, Thuwal (SA)

(73) Assignee: SAUDI BASIC INDUSTRIES CORPORATION, Riyadh (SA)

(21) Appl. No.: 14/193,657

(22) Filed: Feb. 28, 2014

Related U.S. Application Data
(60) Provisional application No. 61/773,309, filed on Mar. 6, 2013.

(51) Int. Cl. B01D 71/58; B01D 67/00; B01D 53/22

(52) U.S. Cl. CPC B01D 71/58; B01D 53/228; B01D 67/009
USPC 428/36.5; 96/4; 95/45; 95/46; 210/650; 521/138; 428/222; 427/515

(57) ABSTRACT

Disclosed are blended polymeric membranes that include at least a first polymer and a second polymer that is UV treated, wherein the first and second polymers are each selected from the group consisting of a polymer of intrinsic microporosity (PIM), a polyetherimide (PEI) polymer, a polyimide (PI) polymer, and a polyetherimide-siloxane (PEI-Si) polymer.

### CROSS REFERENCE TO RELATED APPLICATIONS

This application claims the benefit of U.S. Provisional Application No. 61/773,309, filed Mar. 6, 2013. The contents of the referenced application is incorporated into the present application by reference.

### BACKGROUND OF THE INVENTION

A. Field of the Invention

The present invention relates to polymeric membranes in which polymers are treated through ultra-violet (UV) radiation. The membranes have improved permeability and selectivity parameters for gas, vapour, and liquid separation applications.

B. Description of Related Art

A membrane is a structure that has the ability to separate one or more materials from a liquid, vapour or gas. It acts like a selective barrier by allowing some material to pass through (i.e., the permeate or permeate stream) while preventing others from passing through (i.e., the retentate or retentate stream). This separation property has wide applicability in both the laboratory and industrial settings in instances where it is desired to separate materials from one another (e.g., removal of nitrogen or oxygen from air, separation of hydrogen from gases like nitrogen and methane, recovery of hydrogen from product streams of ammonia plants, recovery of hydrogen in oil refinery processes, separation of methane from the other components of biogas, enrichment of air by oxygen for medical or metallurgical purposes, enrichment of ullage or headspace by nitrogen in inerting systems designed to prevent fuel tank explosions, removal of water vapor from natural gas and other gases, removal of carbon dioxide from natural gas, removal of H₂S from natural gas, removal of volatile organic liquids (VOL) from air of exhaust streams, desiccation or dehumidification of air, etc.).

Examples of membranes include polymeric membranes such as those made from polymers, liquid membranes (e.g., emulsion liquid membranes, immolbilized (supported) liquid membranes, molten salts, etc.), and ceramic membranes made from inorganic materials such as alumina, titanium dioxide, zirconia oxides, glassy materials, etc.).

For gas separation applications, the membrane of choice is typically a polymeric membrane. One of the issues facing polymeric membranes, however, is their well-known trade-off between permeability and selectivity as illustrated by Robeson's upper bound curves (see L. M. Robeson, Correlation of separation factor versus permeability for polymeric membranes, J. Membr. Sci., 62 (1991) 165). In particular, there is an upper bound for selectivity of, for example, one gas over another, such that the selectivity decreases linearly with an increase in membrane permeability. Both high permeability and high selectivity are desirable attributes, however. The higher permeability equates to a decrease in the size of the membrane area required to treat a given volume of gas. This leads to a decrease in the costs of the membrane units. As for higher selectivity, it can result in a process that produces a more pure gas product.

A majority of the polymeric membranes that are currently used in the industry fail to perform above a given Roberson upper bound trade-off curve. That is, a majority of such membranes fail to surpass the permeability-selectivity tradeoff limitations, thereby making them less efficient and more costly to use. As a result, additional processing steps may be required to obtain the level of gas separation or purity level desired for a given gas.

### SUMMARY OF THE INVENTION

A solution to the disadvantages of the currently available membranes has now been discovered. The solution is based on a surprising discovery that a blend of polymers (e.g., at least two or more selected from polymer of intrinsic microporosity (PIM), a polyetherimide (PEI) polymer, a polyimide (PI) polymer, and a polyetherimide-siloxane (PEI-Si) polymer) can be treated together to form membranes that have the desired permeability and selectivity parameters. In some non-limiting embodiments, the UV treatment can result in cross-linking of the polymers. In at least one instance, the membranes have a selectivity of C₃H₆ to C₃H₈ that exceeds the Roberson upper bound trade-off curve. This result is both surprising and synergistic given the selectivity parameters of the individual polymers when compared with the blend currently discovered and disclosed herein. Additionally, the polymeric blended membranes of the present invention have excellent permeability properties for a wide range of gases (e.g., N₂, H₂, CO₂, CH₄, C₂H₄, C₂H₆, C₃H₆, and C₃H₈) as well as selectivity performance (e.g., H₂/N₂, H₂/CO₂, N₂/CH₄, CO₂/N₂, CO₂/CH₄, H₂/CH₄, CO₂/C₂H₄, CO₂/C₂H₆, C₂H₄/C₂H₆, and C₃H₆/C₃H₈). These permeability parameters can be further leveraged in that the faster or slower a gas moves through a particular membrane, the better selectivity can be created for a given pair of gases.

In one particular instance, there is disclosed a membrane comprising at least a first polymer and a second polymer that are treated, wherein the first and second polymers are each selected from the group consisting of a polymer of intrinsic microporosity (PIM), a polyetherimide (PEI) polymer, a polyimide (PI) polymer, and a polyetherimide-siloxane (PEI-Si) polymer. Non-limiting examples of specific types of these polymers are provided throughout this specification and incorporated into this section by reference. In particular instances, the first and second polymers can be different from one another, thereby creating a blend or combination of different polymers that make up the composition. The blend can include at least one, two, three, or all four of said class of polymers. Further, the blend can be from a single class or genus of polymers (e.g., PIM polymer) such that there are at least two different types of PIM polymers in the blend (e.g., PIM-1 and PIM-7 or PIM and PIM-Pi) or from a (PEI) polymer such that there at least two different types of PEI polymers in the blend (e.g., Ultem® and Extern® or Ultem® and Ultem® 1010), or from a PI polymer such that there are at least two different types of PI polymers in the blend, or a PEI-Si polymer such that there are two different types of PEI-Si polymers in the blend. In particular instances, the combination or blend can also include polymers from different classes (e.g., a PIM polymer with a PEI polymer, a PIM polymer with a PI polymer, a PIM polymer with a PEI-Si polymer, PEI polymer with a PI polymer, a PEI polymer with a PEI-Si polymer, or a PI polymer with a PEI-Si polymer). In one instance, the combination can be a (PIM) polymer such as PIM-1 with a PI polymer and the composition can be designed to be a membrane capable of separating a first gas from a second gas, wherein both gases are comprised within a mixture. The membrane can be an ultraviolet treated membrane capable of separating a mixture of gases from one another, wherein the PIM polymer is PIM-1 and the first and second polymers have been treated through ultraviolet radiation such that said membrane performs above its polymer upper bound limit and/or has a selectivity for C₃H₆ over C₃H₈ of at least 5, 6, 7, 8, 9, 10, 11, 12, 13, 14, and up to 15 or ranges from 5 to 15 or ranges from 8 to 15 or ranges from 11 to 15. The membrane can include from 85 to 95% w/w of PIM-1 and from 5 to 15% w/w of the PEI polymer and can be treated with ultraviolet radiation for up to and including 300 minutes or from 60 to 300 minutes or from 120 to 300 minutes or from 120 to 240 minutes or from 150 to 240 minutes. In another instance, the first and second polymers can be treated via a chemical agent, or through heat. The membrane can be in the form of a flat sheet membrane, a spiral membrane, a tubular membrane, or a hollow fiber membrane. In some instances, the membrane can have a uniform density, can be a symmetric membrane, an asymmetric membrane, a composite membrane, or a single layer membrane. The amounts of the polymers within the membrane can vary. In some instances, the membrane can include from 5 to 95% by weight of the first polymer and from 95 to 5% by weight of the second polymer. In particular instances, the membrane can include at least 5, 10, 15, 20, 25, 30, 35, 40, 45, 50, 55, 60, 65, 70, 75, 80, 85, or 95% by weight of the PIM polymer, the PEI polymer, the polyimide (PI) polymer, or the PEI-Si polymer, or any combination of said polymers or all of said polymers. As noted above, treatment through UV radiation can be used. The membrane can be subjected to UV radiation for a period of time to obtain a desired result. In certain instances, the period of time can be up to and including 300 minutes, up to and including 250 minutes, up to and including 200 minutes, up to and including 150 minutes, up to and including 100 minutes, up to and including 50 minutes, or can be from 50 to 300 minutes, or 50 to 250 minutes, or 50 to 200 minutes, or 50 to 150 minutes, or from 50 to 100 minutes, or from 230 to 250 minutes, or from 110 to 130 minutes, or from 50 to 70 minutes. Further, the membrane can further include an additive (e.g., a covalent organic framework (COF) additive, a carbon nanotube (CNT) additive, fumed silica (FS), titanium dioxide (TiO₂) or graphene).

Also disclosed are processes of using the compositions and membranes disclosed throughout this specification. In one instance, the process can be used to separate two materials, gases, liquids, compounds, etc. from one another. Such a process can include contacting a mixture or composition having the materials to be separated on a first side of the composition or membrane, such that at least a first material is retained on the first side in the form of a retentate and at least a second gas is permeated through the composition or membrane to a second side in the form of a permeate. In this sense, the composition or method could include opposing sides, wherein one side is the retentate side and the opposing side is the permeate side. The feed pressure of the mixture to the membrane or the pressure at which the mixture is feed to the membrane can range from 1, 2, 3, 4, 5, 6, 7, 8, 9, 10, 11, 12, 13, 14, or 15 atm or more or can range from 1 to 15 atm, 2 to 10 atm, or from 2 to 8 atm. Further the temperature during the separation step can range from 20, 25, 30, 35, 40, 45, 50, 55, 60, or 65° C. or more or from 20 to 65° C. or from 25 to 65° C. or from 20 to 30° C. The process can further include removing or isolating the either or both of the retentate and/or the permeate from the composition or membrane. The retentate and/or the permeate can be subjected to further processing steps such as a further purification step (e.g., column chromatography, additional membrane separation steps, etc.). In particular instances, the process can be directed to removing at least one of N₂, H₂, CH₄, CO₂, C₂H₄, C₂H₆, C₃H₆, and/or C₃H₈ from a mixture. Examples of processes that the compositions and membranes of the present invention can be used in include gas separation (GS) processes, vapour permeation (VP) processes, pervaporation (PV) processes, membrane distillation (MD) processes, membrane contactors (MC) processes, and carrier mediated processes, sorbent PSA (pressure swing absorption), etc. Further, it is contemplated that at least 2, 3, 4, 5, or more of the same or different membranes of the present invention can be used in series with one another to further purify or isolate a targeted liquid, vapour, or gas material. Similarly, the membranes of the present invention can be used in series with other currently known membranes to purify or isolate a targeted material.

In addition to gas separation applications in the petro-chemical and chemical industries described throughout the specification, the compositions and membranes of the present invention can be used in a variety of other applications and industries. Some non-limiting examples include purification systems to remove microorganisms from air or water streams, potable water purification, ethanol production in a continuous fermentation/membrane pervaporation system, and/or in detection or removal of trace compounds or metal salts in air or water streams. The membranes can also be used in desalination systems to convert salt water into potable water. The membranes can be designed as microfiltration, ultrafiltration, reverse osmosis, or nanofiltration membranes. Also, the membranes can be used as a sensor membrane in (waste) water applications (e.g., analyzing the ion concentration to control the composition of waste water or analyze the content of ions in water samples). Still further, the membranes can be used in medical applications, non-limiting examples of which include drug delivery systems (e.g., controlled release of drugs by using a membrane to moderate the rate of delivery of a drug to the body such as diffusion-controlled systems or osmotic membrane systems or transdermal drug delivery systems—e.g., a drug is released from a device by permeation from its interior reservoir to the surrounding medium), blood oxygenation or artificial lung devices (e.g., membrane oxygenators that perform gas exchange with blood), blood treatments processes (e.g., hemofiltration, hemodialysis, hemodiafiltration, ultrafiltration), diabetes treatments (e.g., devices that utilize membranes for filtration purposes or administration of drugs such as insulins or glucagons or analogues thereof or of islet cells—e.g., artificial pancrease, artificial liver, etc.), diagnostic assays, tissue engineering (e.g., use of polymeric membranes to build scaffolds for isolated cells—the membranes protect the cells from the internal body environment while also providing a scaffold for tissue formation), cell culture and bioreactor systems (transportation of gases into a reaction vessel and transfer of cell culture medium out of the vessel), biosensors (e.g., biosensing device that combine a biological component with a physiochemical detection component to detect analytes in biological feed streams), separation and sorting of biomolecules (e.g., isolation and purification of molecules from various biological feed streams), immunoisolation techniques (e.g., protecting implanted cells or drug release systems from an immune reaction by encapsulation using membranes of the present invention to isolate transplanted cells or drugs from the body's immune system. The membranes can be designed to allow small molecules such as oxygen, glucose, and insulin to pass, but impede the passage of larger immune system molecules such as immunoglobulins), etc. The membranes of the present invention can also be used in the food industry (e.g., cross-flow membrane applications, dairy fractionation, milk and dairy effluents processing, beer, must, and wine processing, fruit juice processing, and membrane emulsification for food applications. In particular, instances, cross-flow microfiltration (MF) membranes can be used to remove non-sucrose compounds, or to fractionate the retentate rich in colourants. Ultrafiltration (UF) membranes can be applied to concentrate the relevant juices in sugar industry and to remove non-sucrose compounds. Reverse osmosis (RO) can be used to recycle pulp press water or to recover pectin from sugar beet pulp. Forward osmosis membrane processes can be used to concentration of sucrose solutions, increase temperature leads to an increase in the draw and feed solute diffusion coefficient and a decrease in water viscosity. The membranes of the present invention can also be used in packaging applications to package, store, ship, or protect articles of manufacture such as food items, electronic devices, household items, toiletries, etc. Another example is the function of the membranes as a barrier for water or moisture or other compounds from entering to active materials in electronic and optoelectronic applications. Still further the membranes of the present invention can also be used in fuel tanks or cells (e.g., the fuel tank or cell can be constructed of a membrane or used in the operation of said fuel tank or cell—one such instance would be proton exchange membrane fuel cells. Another such instance can be the use of membranes in fuel tank inerting systems to allow for an inerting gas to enter the headspace of a tank while also preventing oxygen from entering said headspace or the membranes can act as a barrier for certain fuel or gas from exiting a fuel tank).

In another aspect, there is disclosed a method of making the compositions or membranes disclosed throughout this specification. Such a method can include obtaining a mixture comprising the aforementioned first and second polymers and subjecting the mixture to a treatment step of the first and second polymers blend. The mixture can be a solution that includes the first polymer and the second polymer, wherein both polymers are solubilized or suspended within said solution. The solution can be deposited onto a substrate and dried to form the membrane. Drying can be performed, for example, by vacuum drying or heat drying or both. As noted above, the treatment can be performed by subjecting the composition or membrane to ultraviolet radiation for a period of time to bring about the desired result. Examples include a period of time up to and including 300 minutes, up to and including 250 minutes, up to and including 200, minutes, up to and including 150 minutes, up to and including 100 minutes, up to and including 50 minutes, or can be from 50 to 300 minutes, or from 50 to 250 minutes, or from 50 to 200 minutes, or from 50 to 150 minutes, or from 50 to 100 minutes, or from 230 to 250 minutes, or from 110 to 130 minutes, or from 50 to 70 minutes.

“Inhibiting” or “reducing” or any variation of these terms, when used in the claims or the specification includes any measurable decrease or complete inhibition to achieve a desired result.

“Effective” or “treating” or “preventing” or any variation of these terms, when used in the claims or specification, means adequate to accomplish a desired, expected, or intended result.

The term “about” or “approximately” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The methods, ingredients, components, compositions, etc. of the present invention can “comprise,” “consist essentially of,” or “consist of” particular method steps, ingredients, components, compositions, etc. disclosed throughout the specification. With respect to the transitional phase “consisting essentially of,” in one non-limiting aspect, a basic and novel characteristic of the membranes of the present invention are their permeability and selectivity parameters.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

FIG. 1: Characterization of PIM-1 by Nuclear Magnetic Resonance (NMR).

FIG. 2: Picture of PIM-1 non-UV treated membrane.

FIG. 3A: is a picture of the 90 wt. % PIM-1+10 wt. % Ultem® membrane that has been treated with UV radiation for 240 minutes. FIG. 3B is a picture of the 90 wt. % PIM-1+10 wt. % Extern® membrane that has been treated with UV radiation for 240 minutes.

FIG. 4: Cross-section of a testing cell comprising membrane.

FIG. 5: Flow scheme of the permeability apparatus.

FIG. 6: Gas separation performance for C₃H₆/C₃H₈ of various membranes of the present invention in relation to the C₃H₆/C₃H₈ Robeson's plot and a collection of prior literature data.

### DETAILED DESCRIPTION OF THE INVENTION

Current polymeric membrane materials do not have sufficient permeability/selectivity properties. This leads to inefficiencies in separating techniques and increased costs associated with such techniques.

It has now been discovered that new treated polymeric blends can be used to create membranes that improve on the permeability and selectivity parameters that are currently lacking in today's available membranes. These discovered membranes can be used across a wide range of processes such as gas separation (GS) processes, vapour permeation (VP) processes, pervaporation (PV) processes, membrane distillation (MD) processes, membrane contactors (MC) processes, and carrier mediated processes. The discovery is based on treating at least two different polymers with ultraviolet radiation for a period of time, which results in a membrane having the aforementioned improved properties while also being more economically efficient to make and use.

These and other non-limiting aspects of the present invention are discussed in the following subsections.

### A. Polymers

Non-limiting examples of polymers that can be used in the context of the present invention include polymers of intrinsic microporosity (PIMs), polyetherimide (PEI) polymers, polyetherimide-siloxane (PEI-Si) polymers, and polyimide (PI) polymers. As noted above, the compositions and membranes can include a blend of any one of these polymers (including blends of a single class of polymers and blends of different classes of polymers).

1. Polymers of Intrinsic Microporosity

PIMs are typically characterized as having repeat units of dibenzodioxane-based ladder-type structures combined with sites of contortion, which may be those having spiro-centers or severe steric hindrance. The structures of PIMs prevent dense chain packing, causing considerably large accessible free volumes and high gas permeability. The structure of PIM-1, which was used in the Examples, is provided below:

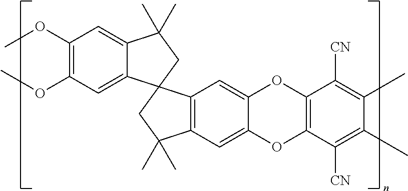

with n being an integer that can be modified as desired. In certain aspects, n is typically greater than 1 or greater than 5 and typically from 10 to 10,000 or from 10 to 1000 or from 10 to 500. PIM-1 can be synthesized as follows:

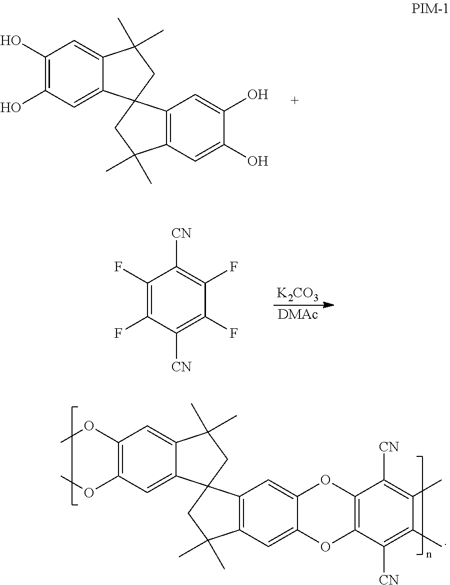

Additional PIMs that can be used in the context of the present invention have the following repeating units:

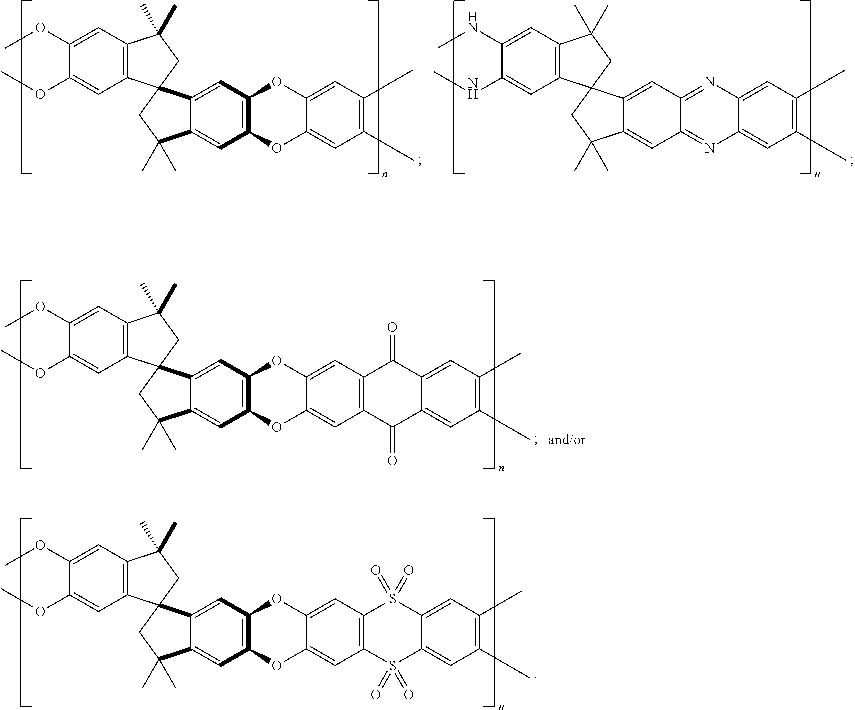

Again, n is typically greater than 1 or greater than 5 and typically from 10 to 10,000 or from 10 to 1000 or from 10 to 500. In some instances, the PIM polymers can be prepared using the following reaction scheme:

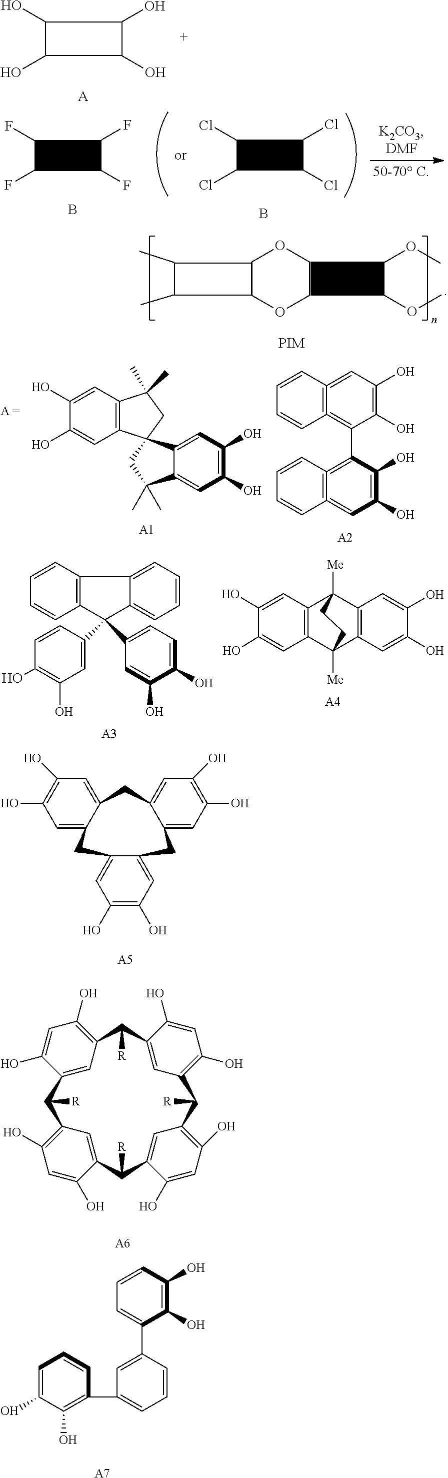

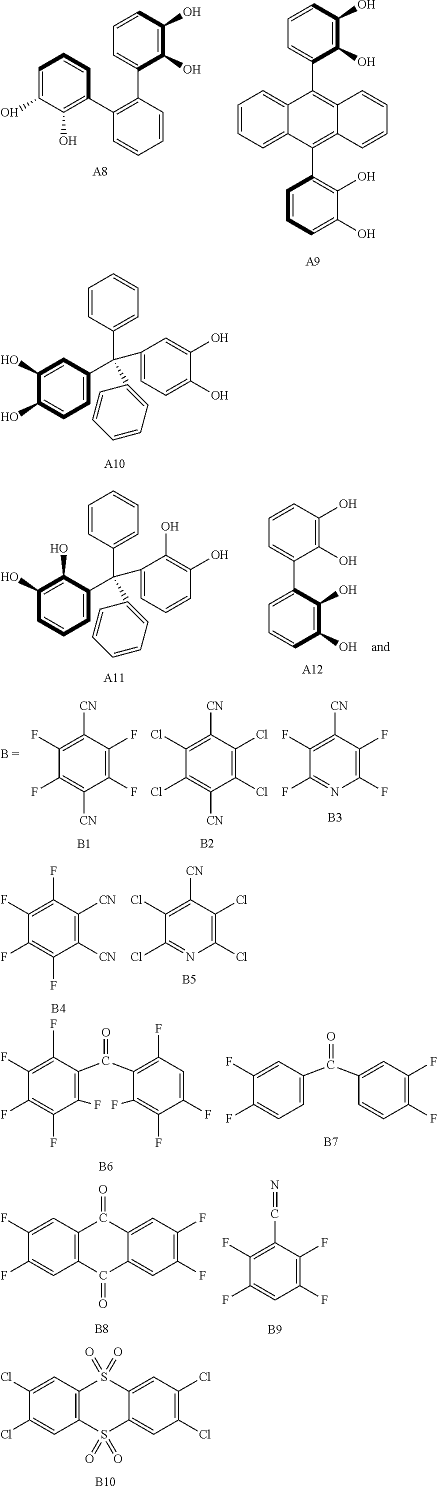

The above structures can further be substituted as desired. Such substitutions include those that add, remove, or substitute alkyl groups, carboxyl groups, carbonyl groups, hydroxyl groups, nitro groups, amino groups, amide groups, azo groups, sulfate groups, sulfonate groups, sulfono groups, sulfhydryl groups, sulfonyl groups, sulfoxido groups, phosphate groups, phosphono groups, phosphoryl groups, and/or halide groups on the polymers used to make the membranes of the present invention. Additional modifications can include an addition or a deletion of one or more atoms of the atomic framework, for example, substitution of an ethyl by a propyl or substitution of a phenyl by a larger or smaller aromatic group. In a cyclic or bicyclic structure, hetero atoms such as N, S, or O can be substituted into the structure instead of a carbon atom.

An additional set of PIM polymers that can be used with the blended polymeric membranes of the present invention include the PIM-PI set of polymers disclosed in Ghanem et. al., High-Performance Membranes from Polyimides with Intrinsic Microporosity, Adv. Mater. 2008, 20, 2766-2771, which is incorporated by reference. The structures of these PIM-PI polymers are:

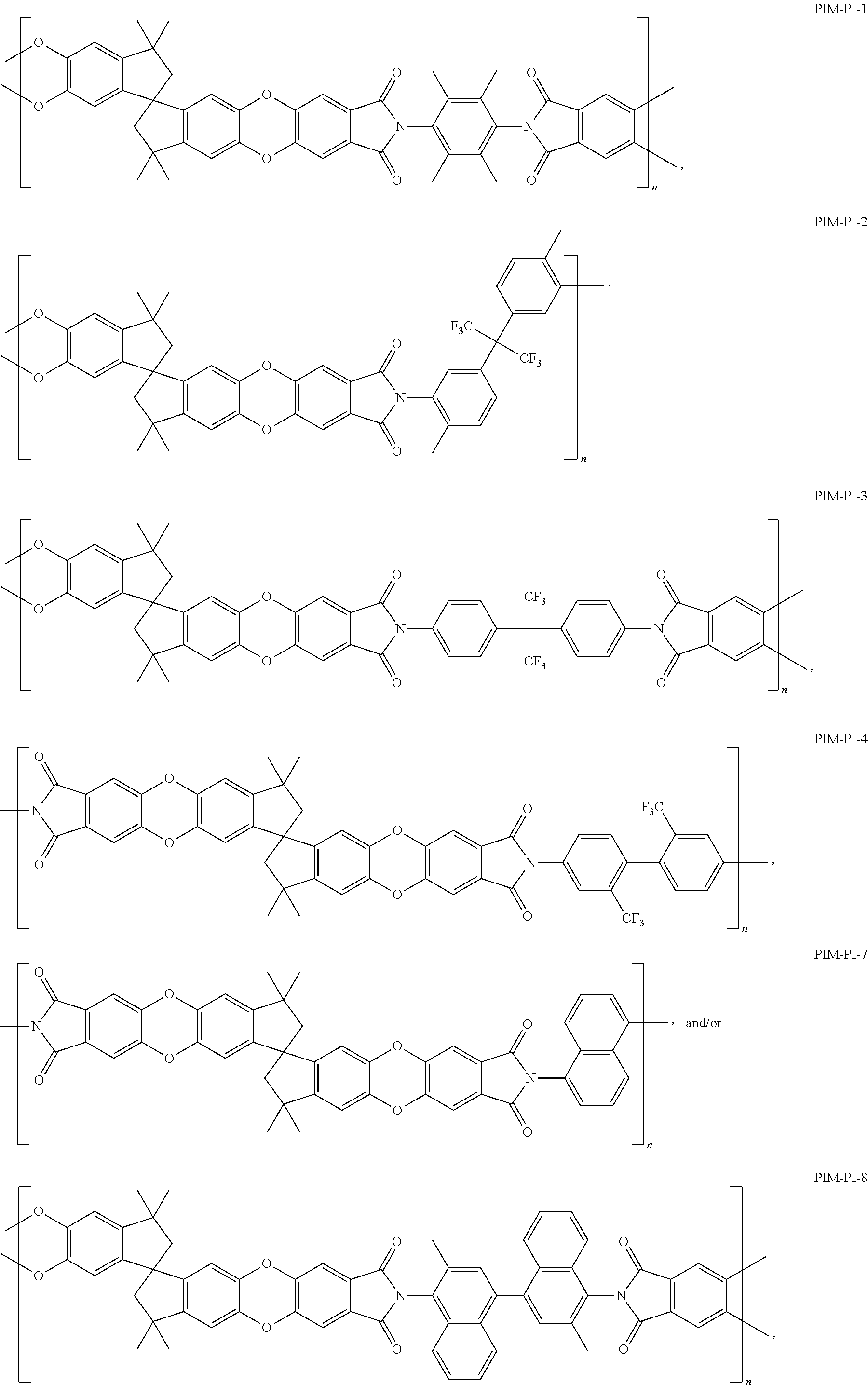

n is typically greater than 1 or greater than 5 and typically from 10 to 10,000 or from 10 to 1000 or from 10 to 500.

Additional PIMs and examples of how to make and use such PIMs are provided in U.S. Pat. No. 7,758,751 and U.S. Publication 2012/0264589, both of which are incorporated by reference.

2. Polyetherimide and Polyetherimide-Siloxane Polymers

Polyetherimide polymers that can be used in the context of the present invention generally conform to the following monomeric repeating structure:

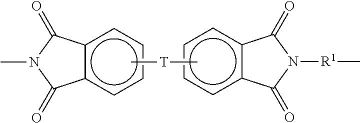

where T and R¹ can be varied to create a wide range of usable PEI polymers. In some instances, the polymers include greater than 1 monomer or greater than 5 and typically from 10 to 10,000 or from 10 to 1000 or from 10 to 500 monomeric units. R¹ can include substituted or unsubstituted divalent organic groups such as: (a) aromatic hydrocarbon groups having 6 to 24 carbon atoms and halogenated derivatives thereof; (b) straight or branched chain alkylene groups having 2 to 20 carbon atoms; (c) cycloalkylene groups having 3 to 24 carbon atoms, or (d) divalent groups of formula (2) defined below. T can be —O— or a group of the formula —O—Z—O— wherein the divalent bonds of the —O— or the —O—Z—O— group are in the 3,3′,3,4′, 4,3′, or the 4,4′ positions. Z can include substituted or unsubstituted divalent organic groups such as: (a) aromatic hydrocarbon groups having about 6 to about 20 carbon atoms and halogenated derivatives thereof; (b) straight or branched chain alkylene groups having about 2 to about 20 carbon atoms; (c) cycloalkylene groups having about 3 to about 20 carbon atoms, or (d) divalent groups of the general formula (2);

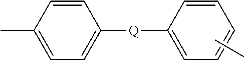

wherein Q can be a divalent moiety selected from the group consisting of —O—, —S—, —C(O)—, —SO₂—, —SO—, —C_{y}H_{2y}— (y being an integer from 1 to 8), and fluorinated derivatives thereof, including perfluoroalkylene groups. Z may comprise exemplary divalent groups of formula (3)

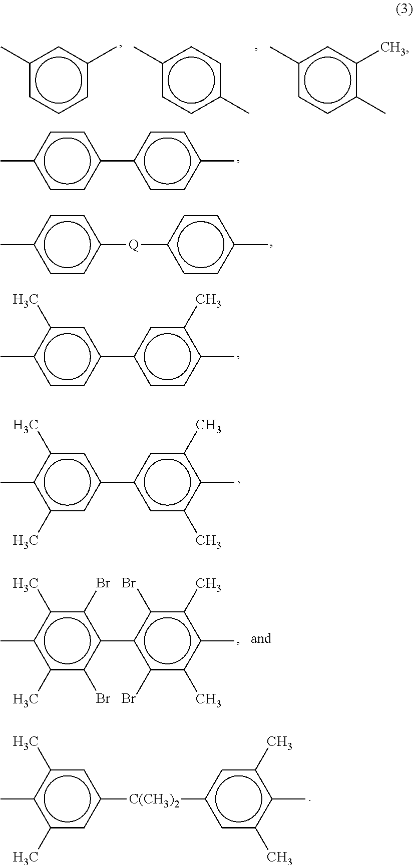

In particular instances, R¹ can be as defined in U.S. Pat. No. 8,034,857, which is incorporated into the present application by reference.

Non-limiting examples of specific PEIs that can be used (and that were used in the Examples) include those commercially available from SABIC Innovative Plastics Holding BV (e.g., Ultem® and Extem®). Ultem® has the following structure:

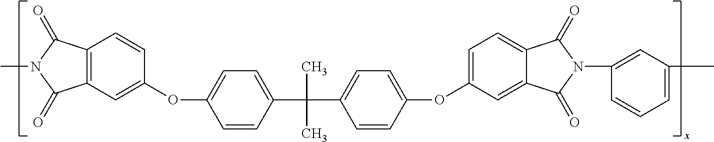

in which x is typically greater than 1 or greater than 5 and typically from 10 to 10,000 or from 10 to 1000 or from 10 to 500. Extern® has the following structure:

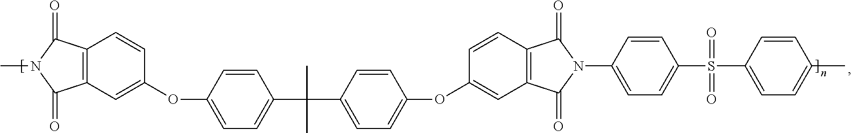

wherein n is typically greater than 1 or greater than 5 and typically from 10 to 10,000 or from 10 to 1000 or from 10 to 500. There are various grades of both Extern® and Ultem® polymers in which the length of the polymer is varied. For instance, Ultem® has a which has a molecular weight of around 55,000 (g/mol), Ultem® (1010) has a molecular weight of around 48,000 (g/mol), and Ultem® (1040) has a molecular weight of around 35,000 (g/mol). All various grades of Extern® and Ultem® are contemplated as being useful in the context of the present invention. Examples of Extern® grades include Extern® (VH1003), Extern® (XH1005), and Extern® (XH1015), which can range in molecular weight (e.g., 41,000 (g/mol)).

Polyetherimide siloxane polymers that can be used in the context of the present invention generally confirm to the following monomeric repeating structure:

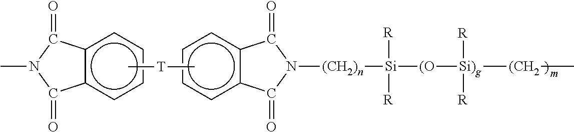

wherein T is defined as described above with respect to polyetherimide polymers, wherein R can be a C₁-C₁₄ monovalent hydrocarbon radical or a substituted C₁-C₁₄ monovalent hydrocarbon radical, and wherein n and m are independently integers from 1 to 10 and g is an integer from 1 to 40. Further, the length of the polymer is typically greater than 1 or greater than 5 and typically from 10 to 10,000 or from 10 to 1000 or from 10 to 500 monomeric units. Additional examples of polyetherimide siloxane polymers are described in U.S. Pat. No. 5,095,060, which is incorporated by reference.

A non-limiting example of a specific PEI-Si that can be used include those commercially available from SABIC Innovative Plastics Holding BV (e.g., Siltem®). Siltem® has the following structure:

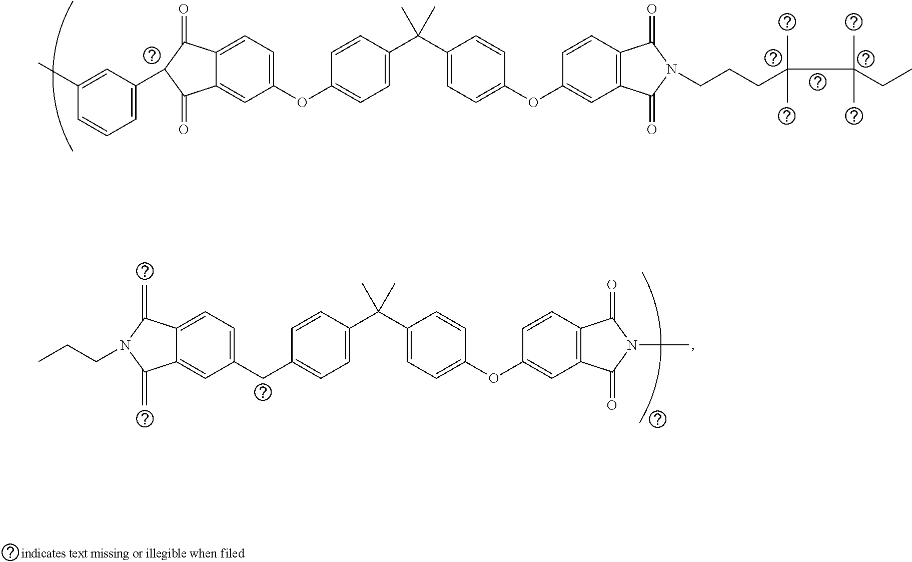

wherein n is typically greater than 1 or greater than 5 and typically from 10 to 10,000 or from 10 to 1000 or from 10 to 500. There are various grades of Siltem® in which the length of the polymer is varied. All various grades of Siltem® are contemplated as being useful in the context of the present invention.

3. Polyimide Polymers

Polyimide (PI) polymers are polymers of imide monomers. The general monomeric structure of an imide is:

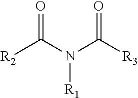

Polymers of imides general take one of two forms: heterocyclic and linear forms. The structures of each are:

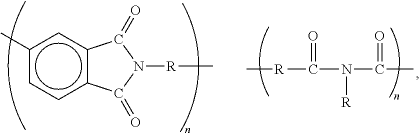

where R can be varied to create a wide range of usable PI polymers. Typically, n is greater than 1 or greater than 5 and typically from 10 to 10,000 or from 10 to 1000 or from 10 to 500. A non-limiting example of a specific PI (i.e., 6FDA-Durene) that can be used is described in the following reaction scheme:

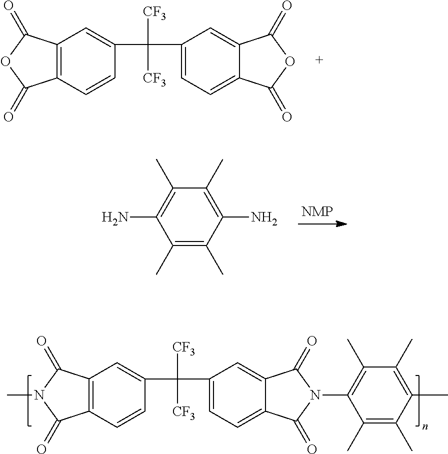

in which n is typically greater than 1 or greater than 5 and typically from 10 to 10,000 or from 10 to 1000 or from 10 to 500.

Additional PI polymers that can be used in the context of the present invention are described in U.S. Publication 2012/0276300, which is incorporated by reference. For instance, such PI polymers include both UV crosslinkable functional groups and pendent hydroxy functional groups: poly[3,3′,4,4′-benzophenonetetracarboxylic dianhydride-2,2-bis(3-amino-4-hydroxyphenyl)-hexafluoropropane] (poly(BTDA-APAF)), poly[4,4′-oxydiphthalic anhydride-2,2-bis(3-amino-4-hydroxyphenyl)-hexafluoropropane] (poly(ODPA-APAF)), poly(3,3′,4,4′-benzophenonetetracarboxylic dianhydride-3,3′-dihydroxy-4,4′-diamino-biphenyl) (poly(BTDA-HAB)), poly[3,3′,4,4′-diphenylsulfone tetracarboxylic dianhydride-2,2-bis(3-amino-4-hydroxyphenyl)-hexafluoropropane] (poly(DSDA-APAF)), poly(3,3′,4,4′-diphenylsulfone tetracarboxylic dianhydride-2,2-bis(3-amino-4-hydroxyphenyl)-hexafluoropropane-3,3′-dihydroxy-4,4′-diamino-biphenyl) (poly(DSDA-APAF-HAB)), poly[2,2′-bis-(3,4-dicarboxyphenyl) hexafluoropropane dianhydride-3,3′,4,4′-benzophenonetetracarboxylic dianhydride-2,2-bis(3-amino-4-hydroxyphenyl)-hexafluoropropane] (poly(6FDA-BTDA-APAF)), poly[4,4′-oxydiphthalic anhydride-2,2-bis(3-amino-4-hydroxyphenyl)-hexafluoropropane-3,3′-dihydroxy-4,4′-diamino-biphenyl] (poly(ODPA-APAF-HAB)), poly[3,3′,4,4′-benzophenonetetracarboxylic dianhydride-2,2-bis(3-amino-4-hydroxyphenyl)-hexafluoropropane-3,3′-dihydroxy-4,4′-diamino-biphenyl] (poly(BTDA-APAF-HAB)), and poly(4,4′-bisphenol A dianhydride-3,3′,4,4′-benzophenonetetracarboxylic dianhydride-2,2-bis(3-amino-4-hydroxyphenyl)-hexafluoropropane] (poly(BPADA-BTDA-APAF)). More generically, the PI polymers can have the following formula (I):

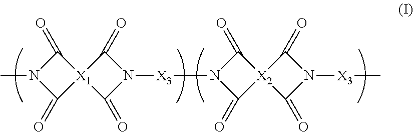

where the length of the polymer or “n” is typically greater than 1 or greater than 5 and typically from 10 to 10,000 or from 10 to 1000 or from 10 to 500, where —X1- of said formula (I) is

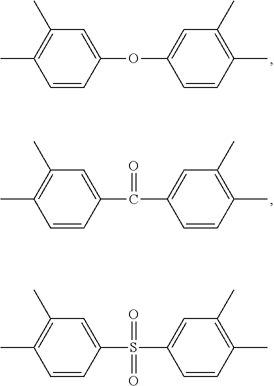

or mixtures thereof, —X2- of said formula (I) is either the same as —X1- or is selected from

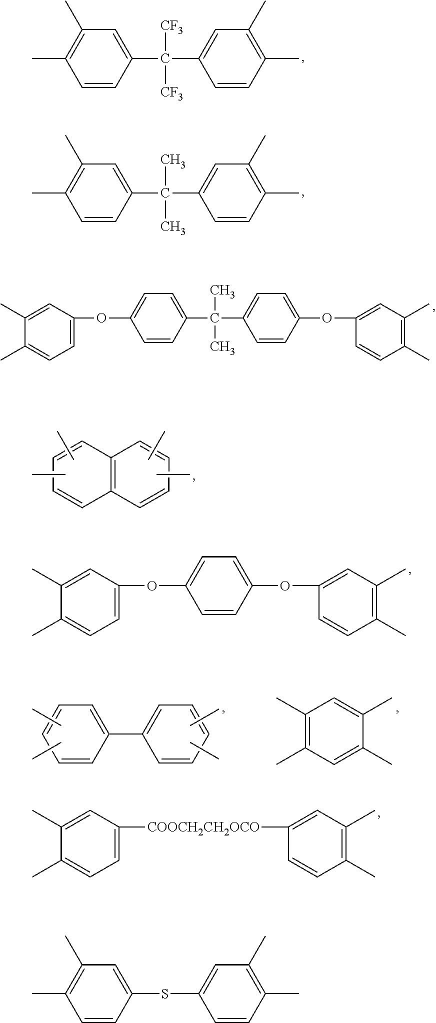

or mixtures thereof, —X3- of said formula (I) is

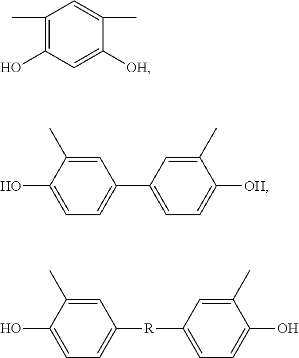

or mixtures thereof, —R— is

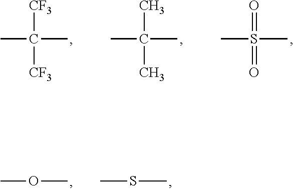

or mixtures thereof.

### B. Method of Making Membranes

There are many known methods for making polymeric membranes. Such methods that can be used include air casting (i.e., the dissolved polymer solution passes under a series of air flow ducts that control the evaporation of the solvents in a particular set period of time such as 24 to 48 hours), solvent or immersion casting, (i.e., the dissolved polymer is spread onto a moving belt and run through a bath or liquid in which the liquid within the bath exchanges with the solvent, thereby causing the formation of pores and the thus produced membrane is further dried), and thermal casting (i.e., heat is used to drive the solubility of the polymer in a given solvent system and the heated solution is then cast onto a moving belt and subjected to cooling).

A particular non-limiting process to make the blended polymeric membranes of the present invention is provided below:
(1) At least two different polymers are dissolved in an appropriate solvent (such as chloroform) and poured onto a glass plate.
(2) The poured material/glass plate is placed into a vacuum oven at mild temperature

(around 70° C.) for up to 2 days to dry.
(3) Upon drying, the membrane thickness is measured (typically 60-10 um thick when dry).
(4) The dried membrane is then placed in a UV curing container for a specified amount of time (at a constant height from the light source).
(5) After UV treatment, the membrane can be tested for single gas permeation or gas mixture permeation.

Permeation testing data is based on single gas measurements (as an example), where the system is evacuated. The membrane is then purged with the desired gas three times. The membrane is tested following the purge for up to 8 hours. To test the second gas, the system is evacuated again and purged three times with this second gas. This process is repeated for any additional gasses. The permeation testing is set at a fixed temperature (20-50° C., preferably 35° C.) and pressure (preferably 2 atm). In addition to UV radiation, cross-linking can also be achieved with chemicals, e-beam, gamma radiation, and/or heat.

### C. Amounts of Polymers and Additives

The amount of polymer to add to the blend can be varied. For example, the amounts of each of the polymers in the blend can range from 5 to 95% by weight of the membrane. In particular aspects, each polymer can be present within the membrane in amounts from 1, 2, 3, 4, 5, 10, 15, 20, 25, 30, 35, 40, 45, 50, 55, 60, 65, 70, 75, 80, 85, or 95% by weight of the composition or membrane. Further, additives such as covalent organic framework (COF) additives, a carbon nanotube (CNT) additives, fumed silica (FS), titanium dioxide (TiO₂) or graphene, etc. can be added in amounts ranging from 1, 2, 3, 4, 5, 6, 7, 8, 9, 10, 15, 20, 25%, or more by weight of the membrane. Such additives can be added to the blend prior to formation of the membrane. and prior to treatment of the membrane.

### D. Membrane Applications

The compositions and membranes of the present invention have a wide-range of commercial applications. For instance, and with respect to the petro-chemical and chemical industries, there are numerous petro-chemical/chemical processes that supply of pure or enriched gases such as He, N₂, and O₂, which use membranes to purify or enrich such gases. Further, removal, recapture, and reuse of gases such as CO₂ and H₂S from chemical process waste and from natural gas streams is of critical importance for complying with government regulations concerning the production of such gases as well as for environmental factors. Also, efficient separation of olefin and paraffin gases is key in the petrochemical industry. Such olefin/paraffin mixtures can originate from steam cracking units (e.g., ethylene production), catalytic cracking units (e.g., motor gasoline production), or dehydration of paraffins. Membranes of the invention can be used in each of these as well as other applications.

For instance, the compositions and membranes of the present invention can be used in the purification, separation or adsorption of a particular species in the liquid or gas phase. In addition to separation of pairs of gases, the membranes can also be used to separate proteins or other thermally unstable compounds. The membranes may also be used in fermenters and bioreactors to transport gases into the reaction vessel and to transfer cell culture medium out of the vessel. Additionally, the membranes can be used to remove microorganisms from air or water streams, water purification, ethanol production in a continuous fermentation/membrane pervaporation system, and/or in detection or removal of trace compounds or metal salts in air or water streams. The membranes can be used in desalination systems to convert salt water into potable water. The membranes can be designed as microfiltration, ultrafiltration, reverse osmosis, or nanofiltration membranes. Also, the membranes can be used as a sensor membrane in (waste) water applications (e.g., analyzing the ion concentration to control the composition of waste water or analyze the content of ions in water samples).

Still further, the membranes of the present invention can be used in medical applications. By way of example, such applications include drug delivery systems (e.g., controlled release of drugs by using a membrane to moderate the rate of delivery of a drug to the body such as diffusion-controlled systems or osmotic membrane systems or transdermal drug delivery systems—e.g., a drug is released from a device by permeation from its interior reservoir to the surrounding medium), blood oxygenation or artificial lung devices (e.g., membrane oxygenators that perform gas exchange with blood), blood treatments processes (e.g., hemofiltration, hemodialysis, hemodiafiltration, ultrafiltration), diabetes treatments (e.g., devices that utilize membranes for filtration purposes or administration of drugs such as insulins or glucagons or analogues thereof or of islet cells—e.g., artificial pancrease, artificial liver, etc.), diagnostic assays, tissue engineering (e.g., use of polymeric membranes to build scaffolds for isolated cells—the membranes protect the cells from the internal body environment while also providing a scaffold for tissue formation), cell culture and bioreactor systems (transportation of gases into a reaction vessel and transfer of cell culture medium out of the vessel), biosensors (e.g., biosensing device that combine a biological component with a physiochemical detection component to detect analytes in biological feed streams), separation and sorting of biomolecules (e.g., isolation and purification of molecules from various biological feed streams), immunoisolation techniques (e.g., protecting implanted cells or drug release systems from an immune reaction by encapsulation using membranes of the present invention to isolate transplanted cells or drugs from the body's immune system. The membranes can be designed to allow small molecules such as oxygen, glucose, and insulin to pass, but impede the passage of larger immune system molecules such as immunoglobulins), etc.

Even further, the membranes of the present invention can be used in the food industry. Non-limiting examples include cross-flow membrane applications, dairy fractionation, milk and dairy effluents processing, beer, must, and wine processing, fruit juice processing, and membrane emulsification for food applications. In particular, instances, cross-flow microfiltration (MF) membranes can be used to remove non-sucrose compounds, or to fractionate the retentate rich in colourants. Ultrafiltration (UF) membranes can be applied to concentrate the relevant juices in sugar industry and to remove non-sucrose compounds. Reverse osmosis (RO) can be used to recycle pulp press water or to recover pectin from sugar beet pulp. Forward osmosis membrane processes can be used to concentration of sucrose solutions, increase temperature leads to an increase in the draw and feed solute diffusion coefficient and a decrease in water viscosity.

The membranes of the present invention can also be used in packaging applications to package, store, ship, and protect articles of manufacture such as food items, electronic devices, household items, toiletries, etc. A further example is the function of the membranes of the present invention as a barrier for water or moisture or other compounds from entering to active materials in electronic and optoelectronic applications. Still further the membranes of the present invention can also be used in fuel tanks or cells (e.g., the fuel tank or cell can be constructed of a membrane or used in the operation of said fuel tank or cell—one such instance would be proton exchange membrane fuel cells. Another such instance can be the use of membranes in fuel tank inerting systems to allow for an inerting gas to enter the headspace of a tank while also preventing oxygen from entering said headspace or the membranes can act as a barrier for certain fuel or gas from exiting a fuel tank).

In another instance, the compositions and membranes can be used in the separation of liquid mixtures by pervaporation, such as in the removal of organic compounds (e.g., alcohols, phenols, chlorinated hydrocarbons, pyridines, ketones) from water such as aqueous effluents or process fluids. By way of example, a membrane that is ethanol-selective could be used to increase the ethanol concentration in relatively dilute ethanol solutions (e.g., less than 10% ethanol or less than 5% ethanol or from 5 to 10% ethanol) obtained by fermentation processes. A further liquid phase separation example that is contemplated with the compositions and membranes of the present invention includes the deep desulfurization of gasoline and diesel fuels by a pervaporation membrane process (see, e.g., U.S. Pat. No. 7,048,846, which is incorporated by reference). Compositions and membranes of the present invention that are selective to sulfur-containing molecules could be used to selectively remove sulfur-containing molecules from fluid catalytic cracking (FCC) and other naphtha hydrocarbon streams. Further, mixtures of organic compounds that can be separated with the compositions and membranes of the present invention include ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and/or ethylacetate-ethanol-acetic acid.

In particular instances, the compositions and membranes of the present invention can be used in gas separation processes in air purification, petrochemical, refinery, natural gas industries. Examples of such separations include separation of volatile organic compounds (such as toluene, xylene, and acetone) from chemical process waste streams and from Flue gas streams. Further examples of such separations include the separation of CO₂ from natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the blended polymeric membranes described herein. More than two gases can be removed from a third gas. For example, some of the gas components which can be selectively removed from a raw natural gas using the membranes described herein include carbon dioxide, oxygen, nitrogen, water vapor, hydrogen sulfide, helium, and other trace gases. Some of the gas components that can be selectively retained include hydrocarbon gases. In further instances, the membranes can be used on a mixture of gasses that include at least 2, 3, 4, or more gases such that a selected gas or gasses pass through the membrane (e.g., permeated gas or a mixture of permeated gases) while the remaining gas or gases do not pass through the membrane (e.g., retained gas or a mixture of retained gases).

Additionally, the compositions and membranes of the present invention can be used to separate organic molecules from water (e.g., ethanol and/or phenol from water by pervaporation) and removal of metal (e.g., mercury(II) ion and radioactive cesium(I) ion) and other organic compounds (e.g., benzene and atrazene) from water).

A further use of the compositions and membranes of the present invention include their use in chemical reactors to enhance the yield of equilibrium-limited reactions by selective removal of a specific product in an analogous fashion to the use of hydrophilic membranes to enhance esterification yield by the removal of water.

The compositions and membranes of the present invention can also be fabricated into any convenient form such as sheets, tubes, spiral, or hollow fibers. They can also be fabricated into thin film composite membranes incorporating a selective thin layer comprising a UV-treated PIM material and a porous supporting layer comprising a different polymer material.

Table 1 includes some particular non-limiting gas separation applications of the present invention.

TABLE 1

| Gas Separation | Application |
|---|---|
| O₂/N₂ | Nitrogen generation, oxygen enrichment |
| H₂/hydrocarbons | Refinery hydrocarbon recovery |
| H₂/CO | Syngas ratio adjustment |
| H₂/N₂ | Ammonia purge gas |
| CO₂/hydrocarbon | Acid gas treating, enhanced oil recovery, landfill |
| | gas upgrading, pollution control |
| H₂S/hydrocarbon | Sour gas treating |
| H₂O/hydrocarbon | Natural gas dehydration |
| H₂O/air | Air dehydration |
| Hydrocarbons/air | Pollution control, hydrocarbon recovery |
| Hydrocarbons from | Organic solvent recovery, monomer recovery |
| process streams | |
| Olefin/paraffin | Refinery |

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Synthesis of PIM-1

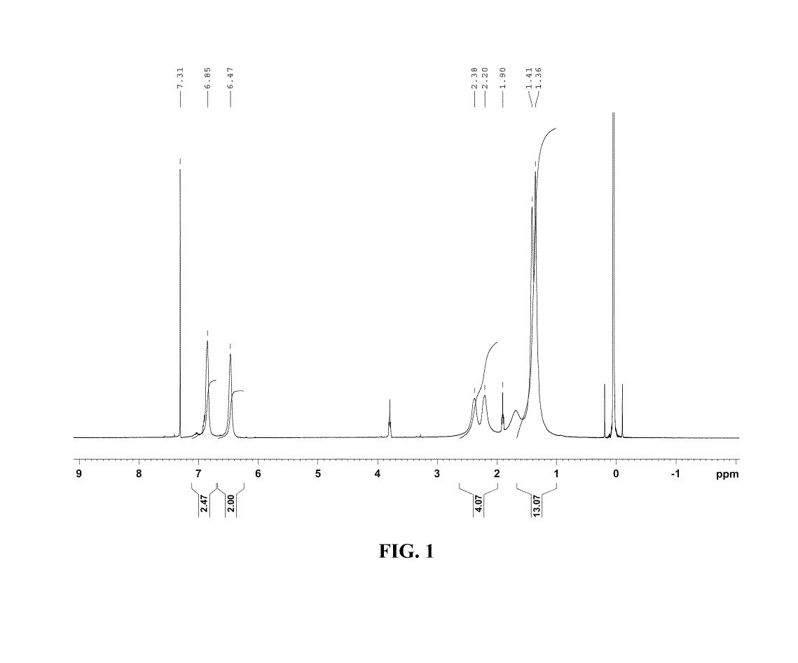

3,3,3′,3′,-tetramethyl-spirobisindan-5,5′6,6′-tetraol (340 mg, 1.00 mmol) and 1,4-dicyanotetrafluorobenzene (200 mg, 1.00 mmol) were dissolved in anhydrous DMAc (2.7 mL), which was stirred at room temperature (i.e., about 20 to 25° C.) for 15 minutes for the totally dissolve of the reagents. Grand K₂CO₃ (390 mg, 2.5 mmol) was added in one portion, the reaction system was stirred at room temperature for another half an hour before been heated to 150° C. The viscosity increased in the first 10 minutes, toluene (3.0 ml) was added in one portion, and the system was stirred at 150° C. for another 10 minutes. The resulting mixture was poured into methanol/water=1/1 solvent, the precipitate was filtered and washed with boiling water for three (3) times, and then dissolved in chloroform and precipitated in methanol. A yellow powder (450 mg, 97.8% yield) was obtained after vacuum drying at 120° C. for 12 hours. Mn 100,000, Mw 200,000, PDI=2.0. Characterization: ¹H NMR (400 MHz, CDCl₃) 6.85 (s, 2H), 6.48 (s, 2H), 2.30 (s, 2H), 2.20 (s, 2H), 1.39 (d, 12H, J=22.8 Hz) (see FIG. 1).

### Example 2

### Membrane Preparation

A PIM-1, an Extem®, an Ultem®, and four PIM-1/PEI dense membranes were prepared by a solution casting method. For the PIM-1/PEI blended membranes, Extem®, Ultem® 1010, Ultem®, and Siltem®, each commercially available from SABIC Innovative Plastics Holding BV, were each used for the PEI component. The PEI component was first dissolved in CH₂Cl₂ and stirred for 4 hours. Subsequently, PIM-1 from Example 1 was added in the solution and stirred overnight. Each of the membranes were prepared with a total 2 wt % polymer concentration in CH₂Cl₂. For the PIM-1/PEI membranes, the blend ratio of PIM-1 to PEI was 90:10 wt % (see Tables 2 and 3 below). The solution was then filtered by 1 μm syringe PTFE filter and transferred into a stainless steel ring supported by a leveled glass plate at room temperature (i.e., about 20 to 25° C.). The polymer membranes were formed after most of the solvent had evaporated after 3 days. The resultant membranes were dried at 80° C. under vacuum for at least 24 hours. The dense films were labeled as (1) PIM-1; (2) Extem®; (3) Ultem®; (4) PIM-1 (90 wt %)-Ultem® (10 wt %), (5) PIM-1 (90 wt %)-Extem® (10 wt %), (6) PIM-1 (90 wt %)-PEI (1010) (10 wt %), and (7) PIM-1 (90 wt %)-PEI (Siloxane) (10 wt %). The membrane thickness was measured by an electronic Mitutoyo 2109F thickness gauge (Mitutoyo Corp., Kanagawa, Japan). The gauge was a non-destructive drop-down type with a resolution of 1 micron. Membranes were scanned at a scaling of 100% (uncompressed tiff-format) and analyzed by Scion Image (Scion Corp., MD, USA) software. The effective area was sketched with the draw-by-hand tool both clockwise and counter-clockwise several times. The thickness recorded is an average value obtained from 8 different points of the membranes. The thicknesses of the casted membranes were about 77±5 μm.

Neither of the PIM, Extern®, and Ultem® membranes were subjected to UV treatment. Treatment of the 90 wt. % PIM-1+10 wt. % Ultem® and 90 wt. % PIM-1+10 wt. % Extern® membranes was performed via exposing the membranes to UV-radiation in a XL-1000 UV machine (Spectro Linker™, Spectronics Corporation) at various times (0 minutes or no UV treatment; 60 minutes, 120 minutes, 180 minutes, 240 minutes).

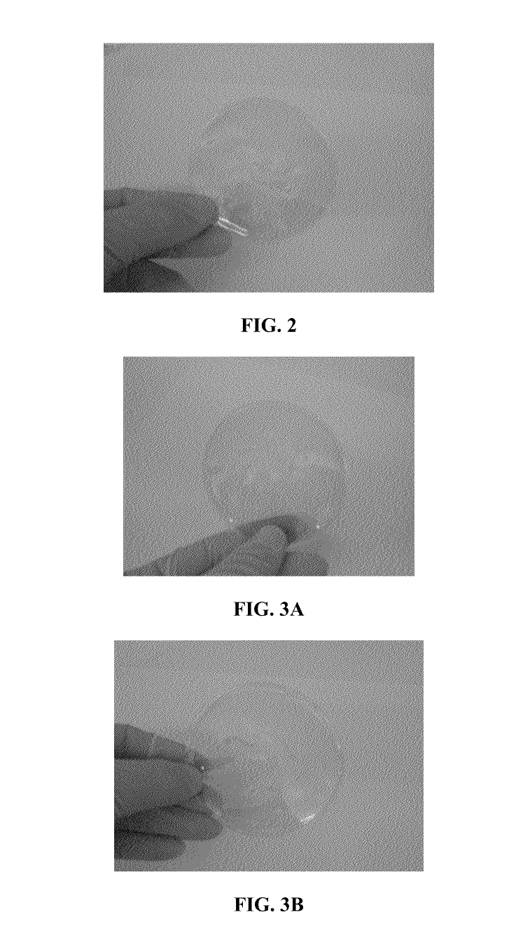

FIG. 2 is a picture of the non-UV-treated PIM-1 membrane. FIG. 3A is a picture of the 90 wt. % PIM-1+10 wt. % Ultem® membrane subjected to UV radiation for 180 minutes.

FIG. 3B is a picture of the 90 wt. % PIM-1+10 wt. % Extem® membrane subjected to UV radiation for 180 minutes.

### Example 3

### Masking of Membranes

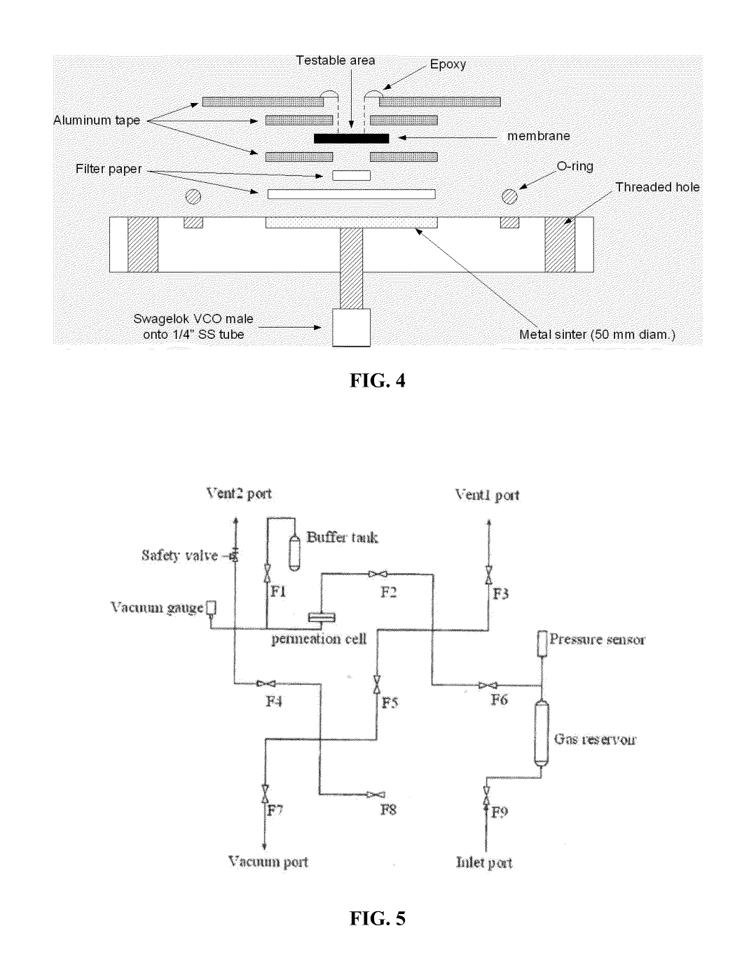

The membranes were masked using impermeable aluminum tape (3M 7940, see FIG. 4). Filter paper (Schleicher & Schuell) was placed between the metal sinter (Tridelta Siperm GmbH, Germany) of the permeation cell and the masked membrane to protect the membrane mechanically. A smaller piece of filter paper was placed below the effective permeation area of the membrane, offsetting the difference in height and providing support for the membrane. A wider tape was put on top of the membrane/tape sandwich to prevent gas leaks from feed side to permeate side. Epoxy (Devcon™, 2-component 5-Minute Epoxy) was applied at the interface of the tap and membrane also to prevent leaks. An O-ring sealed the membrane module from the external environment. No inner O-ring (upper cell flange) was used.

### Example 4

### Permeability and Selectivity Data

The gas transport properties were measured using the variable pressure (constant volume) method. Ultrahigh-purity gases (99.99%) were used for all experiments. The membrane was mounted in a permeation cell prior to degassing the whole apparatus. Permeant gas was then introduced on the upstream side, and the permeant pressure on the downstream side was monitored using a pressure transducer. From the known steady-state permeation rate, pressure difference across the membrane, permeable area and film thickness, the permeability coefficient was determined (pure gas tests). The permeability coefficient, P [cm³ (STP)·cm/cm²·s·cmHg], was determined by the following equation:

$$\text{?} = \frac{1}{\text{?}} \times \frac{V}{A} \times \frac{\text{?}}{\text{?} + \text{?}} \times \frac{L}{760 p} \times \frac{d p}{d t}$$

$$\text{?} \text{indicates text missing or illegible when filed}$$

where A is the membrane area (cm²),

L is the membrane thickness (cm),

p is the differential pressure between the upstream and the downstream (MPa),

V is the downstream volume (cm³),

R is the universal gas constant (6236.56 cm³·cmHg/mol·K),

T is the cell temperature (° C.), and

dp/dt is the permeation rate.

The gas permeabilities of polymer membranes are characterized by a mean permeability coefficient with units of Barrer. 1 Barrer=10⁻¹⁰ cm³ (STP)·cm/cm²·s·cmHg. The gas permeability coefficient can be explained on the basis of the solution-diffusion mechanism, which is represented by the following equation:

P=D≦S

where D (cm²/s) is the diffusion coefficient; and

S (cm³ (STP)/cm³·cmHg) is the solubility coefficient.

The diffusion coefficient was calculated by the time-lag method, represented by the following equation:

$$\text{?} = \text{?}$$

$$\text{?} \text{indicates text missing or illegible when filed}$$

where θ(s) is the time-lag. Once P and D were calculated, the apparent solubility coefficient S (cm³(STP)/cm³·cmHg) may be calculated by the following expression:

$$S = \frac{P}{\text{?}}$$

$$\text{?} \text{indicates text missing or illegible when filed}$$

The ideal selectivity of a dense membrane for gas A to gas B is defined as follows:

$$\text{?} = \frac{\text{?}}{\text{?}} = \text{?} \text{?} \frac{\text{?}}{\text{?}}$$

$$\text{?} \text{indicates text missing or illegible when filed}$$

FIG. 5 provides the flow scheme of the permeability apparatus used in procuring the permeability and selectivity data.

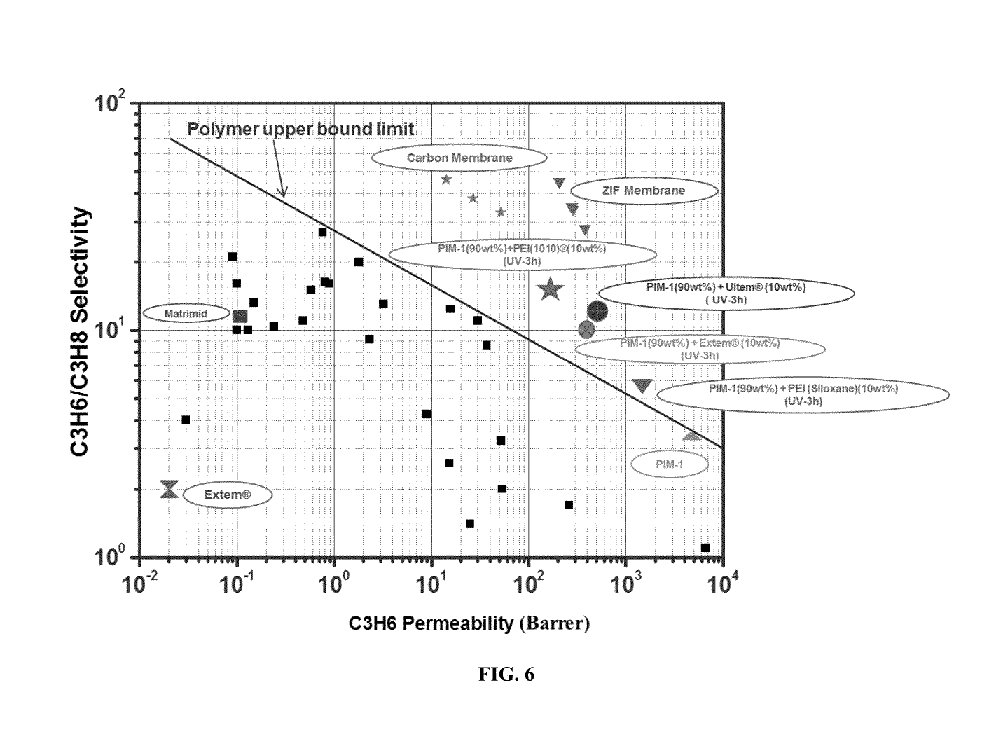

The permeability and selectivity data procured from various membranes using the above techniques are provided in Tables 2 and 3, respectively. Notably, several of the PIM-1/PEI membranes that were UV treated for at least 120 minutes have a gas separation performance for C₃H₆/C₃H₈ above the polymer upper bound limit (see FIG. 6). FIG. 6 represents the selectivity values for C₃H₆ over C₃H₈ as a function of permeability in barrer. Prior literature polymeric membrane permeation data have failed to surpass the upper boundary line (black dots). It is known however that zeolitic and pyrolysis carbon membranes have surpassed such boundary. The data in FIG. 6 confirms that UV-treated membranes of PIM with Ultem® or Extern® have shown combined selectivity and permeability values above the upper boundary for polymeric membranes. Selectivity and permeability values for pure PIM and pure PEI or PEI-Si polymeric membranes are also shown in FIG. 6. In addition, selectivity and permeability data are shown for commercial PI (Marimide) as a baseline.

TABLE 2*
(Permeability (Barrer))

| | | | | Mem- | | | | | | | | |
|---|---|---|---|---|---|---|---|---|---|---|---|---|
| | | | | brane | | | | | | | | |
| | | | | Thick- | | | | | | | | |
| | UV | T | P | ness | | | | | | | | |
| | (min) | (° C.) | (atm) | (μm) | N2 | H2 | CH4 | CO2 | C2H4 | C2H6 | C3H6 | C3H8 |
| PIM-1 | | 25 | 2 | 80 | 435 | 4087 | 583 | 6090 | 2003 | 1202 | 4290 | 1281 |
| Extem | | 25 | 2 | 77 | 0.13 | 9.5 | 0.15 | 3.21 | 0.086 | 0.03 | 0.018 | 0.008 |
| Ultem | | 25 | 2 | 79 | 0.06 | 4.6 | 0.059 | 1.45 | 0.045 | 0.02 | 0.009 | 0.004 |
| PIM-1 | | 35 | 2 | 78 | 460 | 4112 | 594 | 6150 | 2023 | 1243 | 4393 | 1310 |
| Extem | | 35 | 2 | 73 | 0.15 | 10 | 0.16 | 3.32 | 0.09 | 0.04 | 0.02 | 0.01 |
| Ultem | | 35 | 2 | 82 | 0.07 | 4.7 | 0.063 | 1.49 | 0.05 | 0.02 | 0.01 | 0.005 |
| PIM-1(90 wt %)-Ultem(10 wt %) | | 25 | 2 | 73 | 360 | 2454 | 532 | 6615 | 1008 | 568 | 3843 | 1232 |
| PIM-1(90 wt %)-Ultem(10 wt %) | 60 | 25 | 2 | 76 | 234 | 2249 | 380 | 5120 | 477 | 290 | 2250 | 420 |
| PIM-1(90 wt %)-Ultem(10 wt %) | 120 | 25 | 2 | 77 | 179 | 1958 | 250 | 4478 | 500 | 235 | 1182 | 142 |
| PIM-1(90 wt %)-Ultem(10 wt %) | 180 | 25 | 2 | 80 | 112 | 1752 | 141 | 3063 | 248 | 97 | 450 | 41 |
| PIM-1(90 wt %)-Ultem(10 wt %) | 240 | 25 | 2 | 78 | 83 | 1623 | 98 | 2430 | 148 | 48 | 330 | 22 |
| PIM-1(90 wt %)-Extem(10 wt %) | | 35 | 2 | 74 | 351 | 3306 | 416 | 4962 | 1615 | 654 | 2594 | 719 |
| PIM-1(90 wt %)-Extem(10 wt %) | 60 | 35 | 2 | 76 | 305 | 2306 | 306 | 2631 | 609 | 287 | 1352 | 334 |
| PIM-1(90 wt %)-Extem(10 wt %) | 120 | 35 | 2 | 80 | 138 | 1295 | 200 | 1827 | 487 | 210 | 1180 | 231 |
| PIM-1(90 wt %)-Extem(10 wt %) | 180 | 35 | 2 | 78 | 94 | 938 | 131 | 1345 | 209 | 74 | 400 | 41 |
| PIM-1(90 wt %)-Extem(10 wt %) | 240 | 35 | 2 | 80 | 67 | 870 | 72 | 1053 | 121 | 42 | 213 | 17 |
| PIM-1(90 wt %)- | | 25 | 2 | 73 | 297 | 1946 | 490 | 5877 | 967 | 495 | 4443 | 1396 |
| PEI (1010)(10 wt %) | | | | | | | | | | | | |
| PIM-1(90 wt %)- | 180 | 25 | 2 | 79 | 86 | 1727 | 75 | 2980 | 113 | 33 | 164 | 11 |
| PEI (1010)(10 wt %) | | | | | | | | | | | | |
| PIM-1(90 wt %)- | | 25 | 2 | 75 | 268 | 2778 | 413 | 6385 | 761 | 446 | 4578 | 1256 |
| PEI(Siloxane)(10 wt %) | | | | | | | | | | | | |
| PIM-1(90 wt %)- | 180 | 25 | 2 | 81 | 206 | 2380 | 278 | 4920 | 490 | 185 | 1617 | 280 |
| PEI(Siloxane)(10 wt %) | | | | | | | | | | | | |
| Matrimid | | 35 | 2 | 82 | | | | | | | 0.103 | 0.010 |

*PEI (1010) is Ultem ® 1010 and differs from Ultem only by molecular weight. Ultem ® has a molecular weight of around 55,000 (g/mol), whereas Ultem ® (1010) has a molecular weight of around 48,000 (g/mol). Also, Matrimid ® 5218 is a polyimide polymer sold by CIBA Specialty Chemicals (North America).

TABLE 3
(Selectivity)

| | UV | T | P | Membrane | H2/ | H2/ | N2/ | CO2/ | CO2/ | H2/ | CO2/ | C2H4/ | C3H6/ |
|---|---|---|---|---|---|---|---|---|---|---|---|---|---|
| | (min) | (° C.) | (atm) | Thickness (μm) | N2 | CO2 | CH4 | N2 | CH4 | CH4 | C2H4 | C2H6 | C3H8 |
| PIM-1 | | 25 | 2 | 80 | 9.4 | 0.7 | 0.7 | 14.0 | 10.4 | 7.0 | 3.0 | 1.7 | 3.3 |
| Extem | | 25 | 2 | 77 | 73.1 | 3.0 | 0.9 | 24.7 | 21.4 | 63.3 | 37.3 | 2.5 | 2.3 |
| Ultem | | 25 | 2 | 79 | 74.2 | 3.2 | 1.1 | 23.4 | 24.6 | 78.0 | 32.2 | 2.6 | 2.3 |
| PIM-1 | | 35 | 2 | 78 | 8.9 | 0.7 | 0.8 | 13.4 | 10.4 | 6.9 | 3.0 | 1.6 | 3.4 |
| Extem | | 35 | 2 | 73 | 66.7 | 3.0 | 0.9 | 22.1 | 20.8 | 62.5 | 36.9 | 2.3 | 2.0 |
| Ultem | | 35 | 2 | 82 | 70.1 | 3.2 | 1.1 | 22.2 | 23.7 | 74.6 | 29.8 | 2.5 | 2.2 |
| PIM-1(90 wt %)-Ultem(10 wt %) | | 25 | 2 | 73 | 6.8 | 0.4 | 0.7 | 18.4 | 12.4 | 4.6 | 6.6 | 1.8 | 3.1 |
| PIM-1(90 wt %)-Ultem(10 wt %) | 60 | 25 | 2 | 76 | 9.6 | 0.4 | 0.6 | 21.9 | 13.5 | 5.9 | 10.7 | 1.6 | 5.4 |
| PIM-1(90 wt %)-Ultem(10 wt %) | 120 | 25 | 2 | 77 | 10.9 | 0.4 | 0.7 | 25.0 | 17.9 | 7.8 | 9.0 | 2.1 | 8.3 |
| PIM-1(90 wt %)-Ultem(10 wt %) | 180 | 25 | 2 | 80 | 15.6 | 0.6 | 0.8 | 27.3 | 21.7 | 12.4 | 12.4 | 2.6 | 11.0 |
| PIM-1(90 wt %)-Ultem(10 wt %) | 240 | 25 | 2 | 78 | 19.6 | 0.7 | 0.8 | 29.3 | 24.8 | 16.6 | 16.5 | 3.1 | 15.0 |
| PIM-1(90 wt %)-Extem(10 wt %) | | 35 | 2 | 74 | 9.4 | 0.7 | 0.8 | 14.1 | 11.9 | 7.9 | 3.1 | 2.5 | 3.6 |
| PIM-1(90 wt %)-Extem(10 wt %) | 60 | 35 | 2 | 76 | 7.6 | 0.9 | 1.0 | 8.6 | 8.6 | 7.5 | 4.3 | 2.1 | 4.0 |
| PIM-1(90 wt %)-Extem(10 wt %) | 120 | 35 | 2 | 80 | 9.4 | 0.7 | 0.7 | 13.2 | 9.1 | 6.5 | 3.8 | 2.3 | 5.1 |
| PIM-1(90 wt %)-Extem(10 wt %) | 180 | 35 | 2 | 78 | 10.0 | 0.7 | 0.7 | 14.3 | 10.3 | 7.2 | 6.4 | 2.8 | 9.8 |
| PIM-1(90 wt %)-Extem(10 wt %) | 240 | 35 | 2 | 80 | 13.0 | 0.8 | 0.9 | 15.7 | 14.6 | 12.1 | 8.7 | 2.9 | 12.5 |
| PIM-1(90 wt %)-PEI (1010)(10 wt %) | | 25 | 2 | 73 | 6.6 | 0.3 | 0.6 | 19.8 | 12.0 | 4.0 | 6.1 | 2.0 | 3.2 |
| PIM-1(90 wt %)-PEI (1010)(10 wt %) | 180 | 25 | 2 | 79 | 20.2 | 0.6 | 1.1 | 34.8 | 39.7 | 23.0 | 26.3 | 3.5 | 14.9 |
| PIM-1(90 wt %)-PEI | | 25 | 2 | 75 | 10.4 | 0.4 | 0.6 | 23.8 | 15.5 | 6.7 | 8.4 | 1.7 | 3.6 |
| (Siloxane)(10 wt %) | | | | | | | | | | | | | |
| PIM-1(90 wt %)-PEI | 180 | 25 | 2 | 81 | 11.6 | 0.5 | 0.7 | 23.9 | 17.7 | 8.6 | 10.0 | 2.6 | 5.8 |
| (Siloxane)(10 wt %) | | | | | | | | | | | | | |
| Matrimid | | 35 | 2 | 82 | | | | | | | | | 10.9 |

1. A membrane comprising a blend of at least a first polymer and a second polymer that is ultraviolet (UV) treated, wherein the first and second polymers are each selected from the group consisting of a polymer of intrinsic microporosity (PIM), a polyetherimide (PEI) polymer, a polyimide (PI) polymer, and a polyetherimide-siloxane (PEI-Si) polymer.

2. The membrane of claim 1, wherein the first polymer is a (PIM) polymer.

3. The membrane of claim 2, wherein the second polymer is a PEI polymer and the membrane is capable of separating a first gas from a second gas.

4. The membrane of claim 3, wherein the membrane has a selectivity for C₃H₆ over C₃H₈ of at least 5.

5. The membrane of claim 4, wherein the membrane comprises from 85 to 95% w/w of PIM-1 and from 5 to 15% w/w of the PEI polymer, and wherein the membrane was subjected to ultraviolet radiation for 60 to up to 300 minutes or for 120 to 300 minutes or for 120 to 240 minutes or for 150 to 240 minutes.

6. The membrane of claim 1, wherein the membrane is a flat sheet membrane, a spiral membrane, a tubular membrane, or a hollow fiber membrane.

7. The membrane of claim 1, wherein the membrane comprises from 5 to 95% by weight of the first polymer and from 95 to 5% by weight of the second polymer.

8. The membrane of claim 1, wherein the membrane comprises at least 5, 10, 15, 20, 25, 30, 35, 40, 45, 50, 55, 60, 65, 70, 75, 80, 85, or 95% by weight of the PIM polymer, the PEI polymer, the polyimide (PI) polymer, or the PEI-Si polymer, or any combination of said polymers or all of said polymers.

9. The membrane of claim 1, wherein the composition includes at least three or at least four of said polymers.

10. The membrane of claim 1, wherein the membrane was treated with UV radiation for 60 to 300 minutes or for 120 to 300 minutes or for 120 to 240 minutes or for 150 to 240 minutes.

11. The membrane of claim 1, where the membrane further comprises a covalent organic framework (COF) additive, a carbon nanotube (CNT) additive, fumed silica (FS), titanium dioxide (TiO₂) or graphene.

12. The membrane of claim 1, wherein the PEI polymer comprises repeating units of formula: 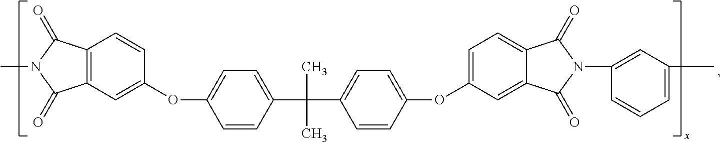
wherein x is an integer from 10 to 10000.

13. The membrane of claim 1, wherein the PEI polymer comprises repeating units of formula: 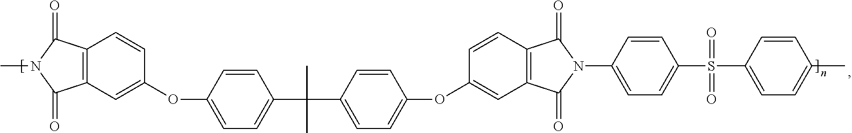
wherein n is an integer from 10 to 10000.

14. A method for separating at least one component from a mixture of components, the process comprising: contacting a mixture of components on a first side of the membrane of claim 1, such that at least a first component is retained on the first side in the form of a retentate and at least a second component is permeated through the membrane to a second side in the form of a permeate.

15. The method of claim 14, wherein the first component is a first gas or a first liquid and the second component is a second gas or a second liquid.

16. The method of claim 15, wherein the first component is a first gas and the second component is a second gas.

17. The method of claim 16, wherein the first gas is an olefin and the second gas is a paraffin.

18. The method of claim 14, wherein the retentate or the permeate is subjected to a purification step.

19. The method of claim 14, wherein the pressure at which the mixture is feed to the membrane is from 2 to 8 atm at a temperature ranging from 20 to 65° C.

20. A method of making the membrane of claim 1 comprising:
(a) obtaining a mixture comprising a first polymer of a polymer of intrinsic microporosity (PIM) and a second polymer selected from the group consisting of a polyetherimide (PEI) polymer, a polyimide (PI) polymer, and a polyetherimide-siloxane (PEI-Si) polymer;
(b) depositing the mixture onto a substrate and drying the mixture to form a membrane; and
(c) subjecting the membrane to ultraviolet radiation in an amount sufficient to treat said membrane.

21. The method of claim 20, wherein the mixture is in liquid form and wherein the first polymer and the second polymer are solubilized within said mixture.

22. The method of claim 21, wherein the solvent is dichloromethane.

23. The method of claim 20, wherein drying comprises vacuum drying or heat drying or both.

24. The method of claim 20, wherein the membrane is subjected to ultraviolet radiation for from 60 to 300 minutes or from 120 to 300 minutes or from 120 to 240 minutes or from 150 to 240 minutes.
